(19) United States
(12) Patent Application Publication
(10) Pub. No.: US 2026/0358068 A1
(43) Pub. Date: Nov. 12, 2026

(54) COOLING HEAT EXCHANGER

(71) Applicant: SUMITOMO RIKO COMPANY LIMITED, Komaki-shi (JP)

(72) Inventors: Ryousuke KANEGAE, Komaki-shi (JP); Yukinori WAKAZONO, Komaki-shi (JP); Kazuki FUJIMOTO, Komaki-shi (JP)

(73) Assignee: SUMITOMO RIKO COMPANY LIMITED, Komaki-shi (JP)

(21) Appl. No.: 19/734,155

(22) Filed: Jul. 8, 2026

Related U.S. Application Data
(63) Continuation of application No. PCT/JP2024/046220, filed on Dec. 26, 2024.

(30) Foreign Application Priority Data
May 14, 2024 (JP) 2024-078513
Oct. 31, 2024 (JP) 2024-192014

(51) Int. Cl. F28F 3/12

(52) U.S. Cl. CPC F28F 3/12; F28F 2215/08

(57) ABSTRACT

A cooling heat exchanger having a novel structure that is expected to further improve cooling performance. A cooling flow path through which a cooling heat medium flows is formed between two plates having a cooling surface, at least one of the plates superposed on a cooling target. At least one protrusion is provided on a wall of the cooling flow path, extending in a direction intersecting a flow path length direction of the cooling flow path. The protrusion is provided with a pair of inclined portions respectively, extending both sides of a flow path width direction toward the flow path length direction of the cooling flow path. The pair of inclined portions comprises a low protruding portion having low height and a high protruding portion having high height.

### INCORPORATED BY REFERENCE

This application is a Continuation of International Application No. PCT/JP2024/046220 filed on Dec. 26, 2024, which claims priority under 35 U.S.C. §§ 119(a) and 365 of Japanese Patent Application Nos. 2024-078513 filed on May 14, 2024, and 2024-192014 filed on Oct. 31, 2024, the disclosures of which are expressly incorporated herein by reference in their entireties.

### BACKGROUND ART

### 1. Technical Field

The present disclosure relates to a cooling heat exchanger to be used for cooling a cooling target that is a battery pack and the like in a motorized vehicle such as an electric car.

### 2. Description of the Related Art

Conventionally, a cooling heat exchanger used for cooling a battery, an inverter, or the like is known. For example, as disclosed in Japanese Unexamined Patent Application Publication No. JP-A-2011-165939, the cooling heat exchanger has a structure in which cooling flow path through which a cooling medium flows is formed in an inner region between a pair of outer shell plates that superpose with each other. Then, the surface of the outer shell plate is cooled by heat exchange with the cooling medium flowing through the cooling flow path, so that the cooling target superposed on the surface is cooled.

### SUMMARY

Meanwhile, in the cooling heat exchanger as JP-A-2011-165939, the cooling medium flowing near the cooling target in the cooling flow path is easily warmed by heat exchange with the cooling target, and the cooling medium flowing away from the cooling target hardly causes heat exchange with the cooling target and is difficult to contribute to the cooling performance. Therefore, in JP-A-2011-165939, a protrusion (reduction portion) protruding toward the cooling flow path is formed, and the cooling medium is stirred by getting over the protrusion.

However, further research conducted by the inventors led to the discovery that the cooling performance is still insufficient even if a protrusion as in JP-A-2011-165939 is provided.

A problem to be solved by the present disclosure is to provide a cooling heat exchanger having a novel structure that is expected to further improve cooling performance.

Hereinafter, preferred embodiments for grasping the present disclosure will be described. However, all the preferred embodiments described below are exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment of the present disclosure provides a cooling heat exchanger in which a cooling flow path through which a cooling heat medium flows is formed between two plates having a cooling surface, at least one of the plates superposed on a cooling target, comprising: at least one protrusion provided on a wall of the cooling flow path, extending in a direction intersecting a flow path length direction of the cooling flow path, wherein the protrusion is provided with a pair of inclined portions respectively, extending both sides of a flow path width direction toward the flow path length direction of the cooling flow path, and the pair of inclined portions comprises a low protruding portion having low height and a high protruding portion having high height.

According to the cooling heat exchanger structured following the present preferred embodiment, since the protrusion has a shape including a pair of inclined portions, the flow of the heat medium that gets over the inclined portion in the substantially its orthogonal direction is guided in the direction inclined in the flow path width direction with respect to the flow path length direction. In this way, by generating the flow of the heat medium not only in the flow path length direction but also in the flow path width direction, the stirring action or the like due to the turbulent flow of the heat medium can be obtained more effectively, and the temperature rise of the heat medium at a position close to the cooling surface can be suppressed in the further downstream side.

In addition, since the low protruding portions and the high protruding portions having mutually different heights are provided at positions different from each other in the flow path width direction in the protrusions, the stirring action of the heat medium by the protrusions, the flow rate of the heat medium, and the like can be made different in the flow path width direction. As a result, the cooling performance can be adjusted in the flow path width direction, and for example, the cooling performance according to the temperature distribution or the like of the cooling target can be realized at a higher level.

A second preferred embodiment provides the cooling heat exchanger according to the first preferred embodiment, wherein the protrusion is V-shaped as viewed in a direction of protruding.

According to the cooling heat exchanger structured following the present preferred embodiment, since the protrusion is formed in a V-shape, the heat medium getting over the protrusion easily forms a turbulence flow such as a vortex, so that improvement of cooling performance by stirring of the heat medium or the like is efficiently realized.

A third preferred embodiment provides the cooling heat exchanger according to the first or second preferred embodiment, wherein height of the protrusion gradually increases from the low protruding portion toward the high protruding portion.

According to the cooling heat exchanger structured following the present preferred embodiment, it is possible to prevent the flow mode of the heat medium from rapidly changing in the flow path width direction, whereby realizing a smooth flow of the heat medium. It is also possible to effectively adjust the cooling performance in the flow path width direction by gradually changing the stirring action, the flow velocity, and the like by the protrusion in the flow path width direction.

A fourth preferred embodiment provides the cooling heat exchanger according to the third preferred embodiment, wherein the at least one protrusion comprises a plurality of protrusions, the plurality of protrusions are arranged in the flow path length direction of the cooling flow path, and the plurality of protrusions arranged in the flow path length direction include a plurality of types in which positions of the low protruding portions in the flow path width direction are different from each other and positions of the high protruding portions in the flow path width direction are different from each other.

According to the cooling heat exchanger structured following the present preferred embodiment, for example, when the required cooling performance in the flow path width direction changes in the flow path length direction, the plurality of types of protrusions having mutually different positions of the low protruding portion and the high protruding portion are appropriately arranged, whereby the required cooling performance can be realized at a higher level.

A fifth preferred embodiment provides the cooling heat exchanger according to any one of the first to fourth preferred embodiments, wherein one of the low protruding portions and the high protruding portion is located at a central portion of the protrusion in the flow path width direction, and the other of the low protruding portion and the high protruding portion is located at both end portions of the protrusion in the flow path width direction.

According to the cooling heat exchanger structured following the present preferred embodiment, for example, the stirring action, the flow rate, and the like can be different between the flow of the heat medium getting over the central portion of the protrusion in the flow path width direction and the flow of the heat medium getting over both end portions of the protrusion in the flow path width direction. Therefore, the influence of the protrusions on the cooling performance can be different between the central portion and end portions in the flow path width direction, and the cooling performance can be adjusted in the flow path width direction.

A sixth preferred embodiment provides the cooling heat exchanger according to the fifth preferred embodiments, wherein the at least one protrusion comprises a plurality of protrusions, the plurality of protrusions are provided in the flow path length direction of the cooling flow path, and the plurality of protrusions include a first protrusion in which the low protruding portion is set at the central portion of the protrusion in the flow path width direction and the high protruding portion is set at both end portions of the protrusion in the flow path width direction, and a second protrusion in which the high protruding portion is set at the central portion of the flow path width direction and the low protruding portion is set at both end portions of the flow path width direction, and the first and second protrusions are alternately arranged in the flow path length direction.

According to the cooling heat exchanger structured following the present preferred embodiment, since the first protrusion in which the low protruding portion is set in the central portion in the flow path width direction and the second protrusion in which the low protruding portion is set at both end portions in the flow path width direction, and they are alternately arranged in the flow path length direction, for example, the flow of the heat medium connecting the low protruding portion in which the flow resistance is easily suppressed is meandering in the flow path width direction, and the stirring action of the heat medium in the flow path width direction can be exhibited. In addition, for example, since the heat medium that has passed through the low protruding portion of one protrusion flows toward the high protruding portion of the next protrusion, it is expected that the heat medium that has smoothly passed through the low protruding portion with a relatively low flow resistance collides with the high protruding portion and so as to be efficiently stirred.

A seventh preferred embodiment provides the cooling heat exchanger according to any one of the first to sixth preferred embodiments, wherein the cooling surface is set on one of the two plates, and the protrusion is formed on other of the two plates.

According to the cooling heat exchanger structured following the present preferred embodiment, by providing the protrusion on the second plate on the side opposite to the first plate having the cooling surface, the heat medium flowing on the side far from the cooling surface in which heat exchange with the cooling target hardly occurs can be effectively stirred by the protrusion. In addition, since the cooling surface is set on the plate different from the plate on which the protrusion is formed, for example, it is possible to prevent the protrusion from affecting the shape of the cooling surface.

An eighth preferred embodiment provides the cooling heat exchanger according to any one of the first to seventh preferred embodiment, wherein a support portion protruding from the other of the two plates is fixed to one of the two plates, and the protrusion is located on a lateral side adjacent to a downstream side of the support portion.

According to the cooling heat exchanger structured following the present preferred embodiment, since the flow of the heat medium separated in the flow path width direction by the support portion is guided to the protrusion located on the lateral side of the downstream side of the support portion, it is possible to efficiently obtain the stirring action or the like by the protrusion.

A ninth preferred embodiment provides the cooling heat exchanger according to any one of the first to eighth preferred embodiment, wherein each of the two plates includes the cooling surface, an inner fin is disposed between the two plates, the cooling flow path is formed on both sides of the inner fin, and the inner fin is provided with a front protrusion, which is the protrusion protruding toward the one of the cooling flow paths, and a back protrusion, which is the protrusion protruding toward the other of the cooling flow paths.

According to the cooling heat exchanger structured following the present preferred embodiment, for example, the cooling target can be cooled by the cooling surfaces on both sides. In addition, since the protrusion is not formed on a plate having the cooling surface but on the inner fin disposed between the plates, for example, it is possible to prevent the protrusion from affecting the shape of the cooling surface. Since the inner fin is provided with a front protrusion and a back protrusion protruding to one side, a stirring action or the like by the protrusion is effectively exerted on both of the two cooling flow paths separated by the inner fin.

A tenth preferred embodiment provides the cooling heat exchanger according to any one of the first to ninth preferred embodiment, wherein the cooling flow path includes a parallel flow path portion including a plurality of flow path portions extending in parallel, and the plurality of protrusions are arranged along the flow path length direction with respect to the flow path portions constituting the parallel flow path portion.

According to the cooling heat exchanger structured following the present preferred embodiment, for example, the flow path width of each flow path portion can be adjusted to adjust the flow of the heat medium while ensuring the flow path width of the cooling flow path in the parallel flow path portion so as to increase the area of the cooling surface. In addition, since the plurality of protrusions are provided in the length direction with respect to the flow path portion, the cooling performance based on the stirring action or the like by the protrusions is improved over a wide range in the length direction of the flow path portion. In the present practical embodiment, the protrusions are not necessarily provided on all of the flow paths, but may be provided with a plurality of protrusions arranged in the flow path length direction in at least one flow path portion.

An eleventh preferred embodiment provides the cooling heat exchanger according to any one of the first to tenth preferred embodiment, wherein a flow path length of the cooling flow path is 200 mm or more.

In a long cooling flow path of 200 mm or more, such as the cooling heat exchanger structured following the present preferred embodiment, the heat medium in the downstream side tends to be higher in temperature due to heat exchange with the cooling target over a long period of time. Therefore, by providing the protrusion including the low protruding portion and the high protruding portion in the pair of inclined portions and the heat medium is efficiently stirred. Accordingly, even when the flow path length of the cooling flow path is long, it is possible to suppress the temperature rise of the heat medium on the downstream side, and maintain the cooling performance in the further downstream side.

A twelfth preferred embodiment provides the cooling heat exchanger according to any one of the first to tenth preferred embodiment, wherein the protrusion extends across entire of the flow path width of the cooling flow path and is continuous with side walls of the cooling flow path at its both end portions.

According to the cooling heat exchanger structured following the present preferred embodiment, it is possible to prevent the flow of the heat medium bypassing the protrusion and then flowing between the side wall of the cooling flow path and the protrusion. Accordingly, it is possible to efficiently improve the cooling performance. In addition, when the protrusion is far from the side wall of the cooling flow path, the heat medium flowing between the side wall of the cooling flow path and both end portions of the protrusion is likely to be fast, which may cause scraping of the wall and the protrusion of the cooling flow path. However, in the cooling heat exchanger according to the present practical embodiment, since the protrusion extends across entire of the flow path width of the cooling flow path and is continuous with a side wall of the cooling flow path at its each end portion, the heat medium can be prevented from flowing between the side wall of the cooling flow path and the protrusion, and scraping of the wall and the protrusion of the cooling flow path is prevented.

A thirteenth preferred embodiment provides the cooling heat exchanger according to any one of the first to twelfth preferred embodiment, wherein the protrusion has a cross-sectional shape tapered toward its protruding top in a cross section of the flow path length direction of the cooling flow path, the protrusion has an arc-shaped protruding top, an upstream inclined portion, and a downstream inclined portion, and these portions provided smoothly and continuously without a corner portion, the upstream inclined portion extending from the protruding top toward a protruding base that is a side of a bottom surface of the cooling flow path so as to be inclined toward an upstream side of the cooling flow path, and the downstream inclined portion extending from the protruding top toward the protruding base so as to be inclined toward a downstream side.

According to the cooling heat exchanger structured following the present preferred embodiment, since the surface of the protrusion is smoothly continuous in the cross section of the flow path length direction, the flow of the heat medium over the protrusion is smoothly generated.

A fourteenth preferred embodiment provides the cooling heat exchanger according to any one of the thirteenth preferred embodiment, wherein, in the cross section of the flow path length direction of the cooling flow path, a radius of curvature of the protruding top is within a range of 0.05-1.5 times a length dimension of the protrusion base, and in the cross section of the flow path length direction of the cooling flow path, an inclination angle of the upstream inclined portion with respect to the bottom surface of the cooling flow path is within a range of 20°-70°.

According to the cooling heat exchanger structured following the present preferred embodiment, since the radius of curvature of the protruding top is 0.05 times or more the length dimension of the protrusion base, the protrusion top has a smooth arc-shaped cross section without a substantial corner portion. Further, since the radius of curvature of the protruding top is 1.5 times or less the length dimension of the protrusion base, it is possible to prevent the length dimension in the flow path length direction of the protrusion from becoming excessively long, and it is also possible to sufficiently set the inclination angle of the protrusion top with respect to the bottom surface of the upstream inclined portion and the downstream inclined portion that are smoothly continuous.

Since the inclination angle of the upstream inclined portion with respect to the bottom surface of the cooling flow path is 20° or more, the flow of the heat medium from the upstream side toward the protrusion is effectively disturbed by the upstream inclined portion, so that the cooling performance by the stirring action is improved. Further, since an inclination angle of the upstream inclined portion with respect to the bottom surface of the cooling flow path is 70° or less, it is possible to prevent the flow of the heat medium from being excessively limited by the protrusion.

A fifteenth preferred embodiment provides the cooling heat exchanger according to any one of the thirteenth preferred embodiment, wherein, in the cross section of the flow path length direction of the cooling flow path, an inclination angle of the upstream inclined portion with respect to the bottom surface of the cooling flow path is 25° or less.

According to the cooling heat exchanger structured following the present preferred embodiment, since the inclination angle of the upstream inclined portion with respect to the bottom surface of the cooling flow path is 25° or less, it is possible to set pressure loss sufficiently small. For example, the heat medium can be flew using an inexpensive pump having lower performance.

A sixteenth preferred embodiment of the present disclosure provides a cooling heat exchanger in which a cooling flow path through which a cooling heat medium flows is formed and which cools a cooling target superposed on a cooling surface, comprising: a protrusion provided on a wall of the cooling flow path, extending in a direction intersecting a flow path length direction of the cooling flow path, wherein the protrusion is provided with a pair of inclined portions respectively, extending both sides of a flow path width direction toward the flow path length direction of the cooling flow path, and the pair of inclined portions comprises a low protruding portion having low height and a high protruding portion having high height.

According to the cooling heat exchanger structured following the present preferred embodiment, the same effects as those of the cooling heat exchanger described as the first practical embodiment can be obtained. In addition, for example, even in a case where the wall of the cooling flow path is formed of one member such as a tube shape instead of two plates, the cooling performance can be improved by providing the protrusion having the above-described structure including the low protruding portion and the high protruding portion in the cooling flow path inside.

According to the present disclosure, it is possible to further improve the cooling performance in the cooling heat exchanger.

### BRIEF DESCRIPTION OF THE DRAWINGS

The foregoing and/or other objects, features and advantages of the disclosure will become more apparent from the following description of a practical embodiment with reference to the accompanying drawings in which like reference numerals designate like elements and wherein:

FIG. 1 is an exploded perspective view depicting a cooling heat exchanger according to a first practical embodiment of the present disclosure;

FIG. 2 is a sectional view of the cooling heat exchanger depicted in FIG. 1, corresponding to the cross section taken along 2-2 of FIG. 2;

FIG. 3 is a sectional view taken along 3-3 of FIG. 2;

FIG. 4 is an enlarged sectional view taken along 4-4 of FIG. 3;

FIG. 5 is an enlarged sectional view taken along 5-5 of FIG. 3;

FIG. 6 is an exploded perspective view depicting a cooling heat exchanger according to a second practical embodiment of the present disclosure;

FIG. 7 is a sectional view of the cooling heat exchanger depicted in FIG. 6, corresponding to the cross section taken along 7-7 of FIG. 8;

FIG. 8 is a sectional view taken along 8-8 of FIG. 7;

FIG. 9 is a sectional view of the cooling heat exchanger depicted in FIG. 6, corresponding to the cross section taken along 9-9 of FIG. 10;

FIG. 10 is an enlarged sectional view taken along 10-10 of FIG. 9;

FIG. 11 is an enlarged sectional view taken along 11-11 of FIG. 9;

FIG. 12 is a sectional view depicting a cooling heat exchanger according to another practical embodiment of the present disclosure;

FIG. 13 is a sectional view depicting a cooling heat exchanger according to third practical embodiment of the present disclosure, corresponding to the cross section taken along 13-13 of FIG. 14;

FIG. 14 is an enlarged sectional view taken along 14-14 of FIG. 13;

FIG. 15 is an enlarged sectional view taken along 15-15 of FIG. 13;

FIG. 16 is a sectional view depicting a cooling heat exchanger according to fourth practical embodiment of the present disclosure;

FIG. 17 is an exploded perspective view depicting a cooling heat exchanger according to a fifth practical embodiment of the present disclosure;

FIG. 18 is a plane view of an inner fin constituting a cooling heat exchanger according to a sixth practical embodiment of the present disclosure;

FIG. 19 is a partial sectional view of an inner fin depicted in FIG. 18, corresponding to the cross section taken along 19-19 of FIG. 20;

FIG. 20 is an enlarged sectional view taken along 20-20 of FIG. 18;

FIG. 21 is an enlarged sectional view taken along 21-21 of FIG. 18;

FIG. 22 is a plane view of an inner fin constituting a cooling heat exchanger according to a seventh practical embodiment of the present disclosure;

FIG. 23 is an enlarged view of the section along 23-23 of FIG. 22;

FIG. 24 is an enlarged view of the section along 24-24 of FIG. 22; and

FIG. 25 is a partial sectional view of an inner fin constituting a cooling heat exchanger according to another practical embodiment of the present disclosure.

### DETAILED DESCRIPTION

Hereinafter, practical embodiments of the present disclosure will be described in reference to the drawings.

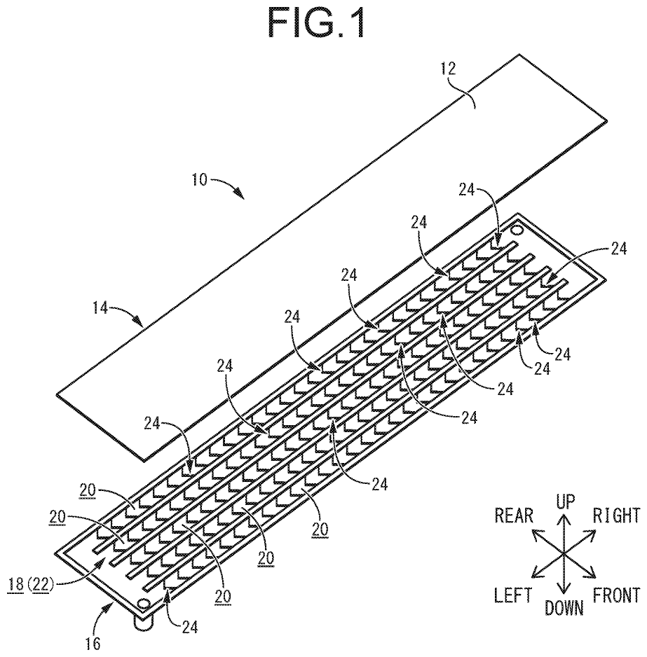

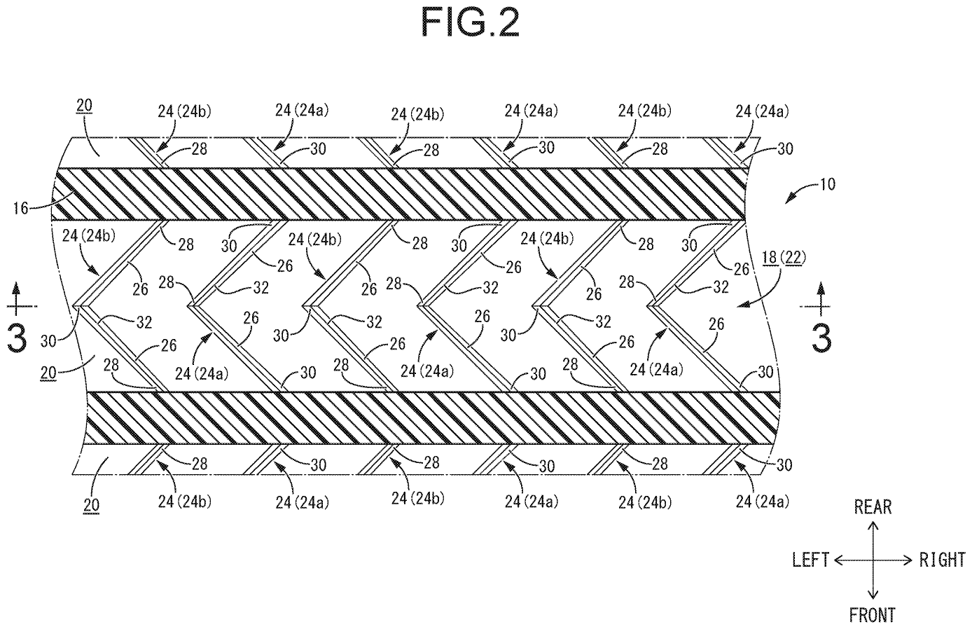

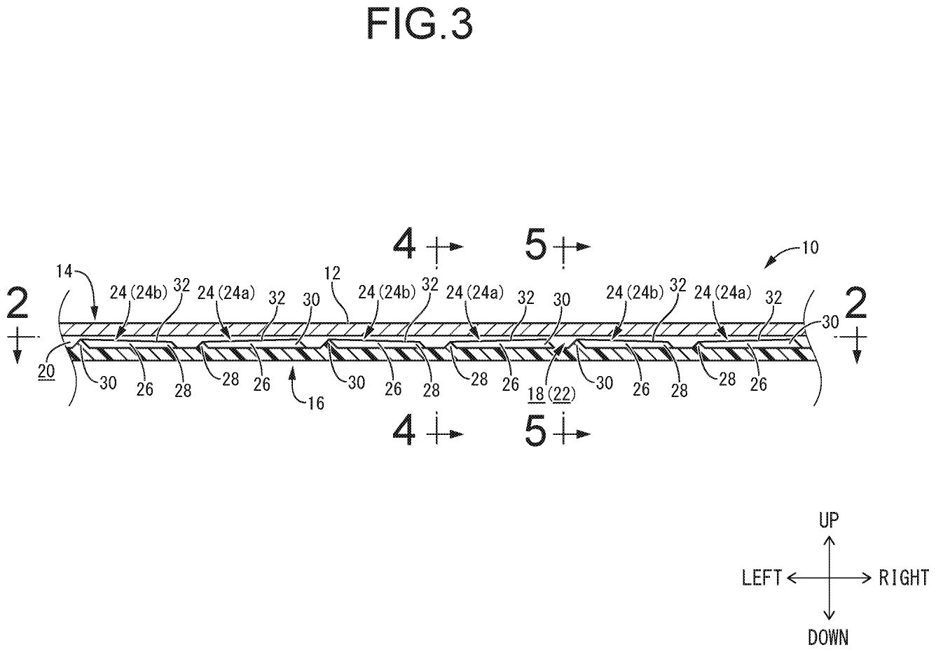

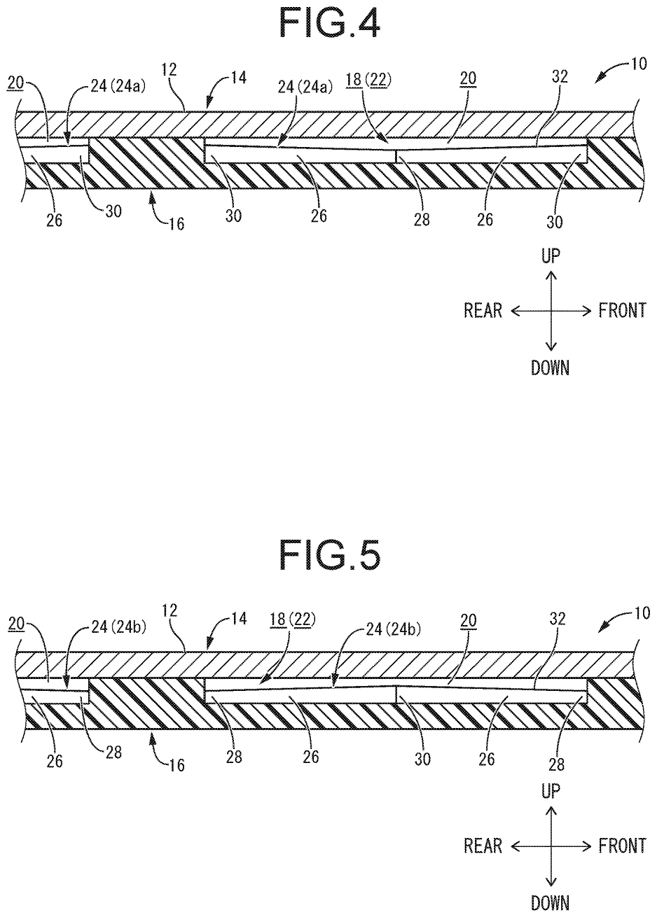

FIGS. 1-5 show a cooling heat exchanger 10 according to a first practical embodiment of the present disclosure. The cooling heat exchanger 10 has a structure in which a flat plate-shaped upper plate 14 having a cooling surface 12 is superposed on a concave lower plate 16, and a cooling flow path 18 through which a cooling heat medium flows is formed between the upper plate 14 and the lower plate 16. The cooling heat exchanger 10 is configured to cool a cooling target such as a battery (not shown) superposed on the cooling surface 12 by heat exchange with the heat medium via the upper plate 14.

The flow path length of the cooling flow path 18 is preferably 200 mm or more, more preferably 300 mm or more, and even more preferably 500 mm or more. The cooling flow path 18 has a parallel flow path portion 22 constituted by a plurality of flow path portions 20 extending in parallel, and the protrusion 24 protrudes from the bottom wall of the flow path portion 20. The protrusion 24 is formed integrally with the lower plate 16, protrudes toward the upper plate 14, and extends in a direction intersecting the flow path length direction of the flow path portion 20. The protrusion 24 includes a pair of inclined portions 26, 26 extending toward both sides in the flow path width direction toward the flow path length direction, and has a V-shape tapered toward the upstream side when viewed in the vertical direction. The inclined portion 26 of the protrusion 24 extends linearly in the flow path intersecting direction in a substantially triangular cross-sectional shape. The plurality of protrusions 24 are provided so as to be aligned in the flow path length direction in the flow path portion 20. The protrusions 24 of the present practical embodiment are provided continuously over the entire flow path width direction of the flow path portion 20, and both end portions thereof are continuous with the side wall of the flow path portion 20. Therefore, in the present practical embodiment, there is no gap that lacks protrusion 24 between the protrusion 24 and the side wall of the flow path portion 20.

The pair of inclined portions 26, 26 of the protrusion 24 are provided with a low protruding portion 28 having low height and a high protruding portion 30 having high height. The protrusion height of the protrusion 24 gradually (continuously) increases from the low protruding portion 28 toward the high protruding portion 30. The protrusion height of the protrusion 24 refers to the vertical distance from the inner surface of the bottom wall of the flow path portion 20 to the ridge line 32.

The protrusion 24 includes a first protrusion 24a in which the low protruding portion 28 is set at a central portion in the flow path width direction and the high protruding portions 30, 30 are set at both end portions, and a second protrusion 24b in which the high protruding portion 30 is set at a central portion in the flow path width direction and the low protruding portions 28, 28 are set at both end portions. Therefore, the plurality of protrusions 24 provided so as to be aligned in the length direction of the flow path portion 20 include two types (first protrusion 24a and second protrusion 24b) in which the positions of the low protruding portions 28 in the flow path width direction are different from each other and the positions of the high protruding portions 30 in the flow path width direction are different from each other. The plurality of protrusions 24 provided on the flow path portion 20 of the present practical embodiment are configured such that the first protrusions 24a and the second protrusions 24b are alternately arranged in the flow path length direction.

In the cooling heat exchanger 10 having the structure according to the present practical embodiment, a battery pack (not shown) as a cooling target is superposed on the cooling surface 12. Then, the low-temperature heat medium is supplied from the upstream side to the cooling flow path 18, and the heat medium flows from the upstream side to the downstream side of the cooling flow path 18, so that heat exchange occurs between the heat medium and the battery pack via the upper plate 14, and the battery pack is cooled by the cooling heat exchanger 10.

Due to the heat exchange with the battery pack, the heat medium flowing in the upper portion of the cooling flow path 18 close to the upper plate 14 tends to be higher than the heat medium flowing through the lower portion of the cooling flow path 18 far from the upper plate 14. Considering the above, the cooling flow path 18 is provided with the protrusion 24, and when the heat medium flows over the protrusion 24, the flow is disturbed and the stirring action of the heat medium is exhibited. Accordingly, the heat medium flowing in the upper portion of the cooling flow path 18 and the heat medium flowing in the lower portion are mixed, so that the temperature difference in the vertical direction in the cooling flow path 18 is reduced. As a result, the temperature difference between the heat medium flowing in the upper portion of the cooling flow path 18 and the battery pack can be kept large in the further downstream side of the cooling flow path 18, and excellent cooling performance can be obtained over a wider range of the cooling surface 12.

The flow path length of the cooling flow path 18 of the present practical embodiment is preferably 200 mm or more, more preferably 300 mm or more, and even more preferably 500 mm or more. Even when such a long cooling flow path 18 is provided, the cooling performance can be assured in the further downstream side by improving the cooling performance by the stirring action of the protrusion 24.

The protrusion 24 has a V-shape narrowed toward the upstream side in a top view, and includes the pair of inclined portions 26, 26. Since the flow of the heat medium over the pair of inclined portions 26, 26 is likely to be formed in the direction orthogonal to the pair of inclined portions 26, 26 (the ridge line 32), for example, the heat medium getting over the pair of inclined portions 26, 26 flows so as to approach each other toward the inner side in the flow path width direction, and the flow of the heat medium merges with each other on the downstream side of the protrusion 24. As a result, the flow of the heat medium is more strongly disturbed on the downstream side of the protrusion 24, and the stirring action is effectively exhibited. Furthermore, for example, a vortex flow is formed by merging of the flow of the heat medium over the pair of inclined portions 26, 26, and efficient stirring of the heat medium by the vortex flow is also expected.

The protrusion 24 includes the first protrusion 24a in which the low protruding portion 28 is set at the central portion in the flow path width direction and the high protruding portions 30, 30 are set at both end portions, and the second protrusion 24b in which the high protruding portion 30 is set at the central portion in the flow path width direction and the low protruding portions 28, 28 are set at both end portions. As described above, by adopting the protrusions 24 that change height in the flow path width direction, the stirring action of the heat medium by the protrusion 24, the flow rate of the heat medium, and the like can be made different in the flow path width direction. As a result, the cooling performance can be adjusted in the flow path width direction of the cooling flow path 18, and the cooling heat exchanger 10 having cooling performance in accordance with, for example, the temperature distribution of the battery pack can be provided.

In the protrusion 24 of the present practical embodiment, the protrusion height dimension continuously changes in the length direction of the pair of inclined portions 26, 26. Therefore, it is possible to prevent the flow mode of the heat medium from rapidly changing in the flow path width direction, whereby realizing a smooth flow of the heat medium. It is also possible to effectively adjust the cooling performance in the flow path width direction by gradually changing the stirring action, the flow velocity, and the like by the protrusion 24 in the flow path width direction.

In the present practical embodiment, the first protrusion 24a and the second protrusion 24b are alternately arranged in the flow path length direction of the cooling flow path 18. As a result, when the heat medium flows through the low protruding portion 28 having a relatively small flow resistance, for example, by alternately passing the low protruding portion 28 of the first protrusion 24a located at the center in the flow path width direction and the low protruding portions 28, 28 of the second protrusion 24b located at both ends in the flow path width direction, the meandering flow of the heat medium is formed so that the stirring action of the heat medium due to the meandering flow is expected.

In addition, since the first protrusion 24a and the second protrusion 24b are alternately arranged in the flow path length direction of the cooling flow path 18, for example, the heat medium that has passed through the low protruding portion 28 of the first protrusion 24a flows toward the high protruding portion 30 of the second protrusion 24b disposed adjacent to the downstream side of the first protrusion 24a. As a result, the heat medium smoothly that has passed through the low protruding portion 28 of the first protrusion 24a collides with the high protruding portion 30 of the second protrusion 24b, whereby the flow of the heat medium is strongly disturbed, and the stirring action can be advantageously exhibited. Similarly, since the heat medium that has passed through the low protruding portions 28, 28 of the second protrusion 24b collides with the high protruding portions 30, 30 of the first protrusion 24a disposed adjacent to the downstream side of the second protrusion 24b, the stirring action of the heat medium is expected.

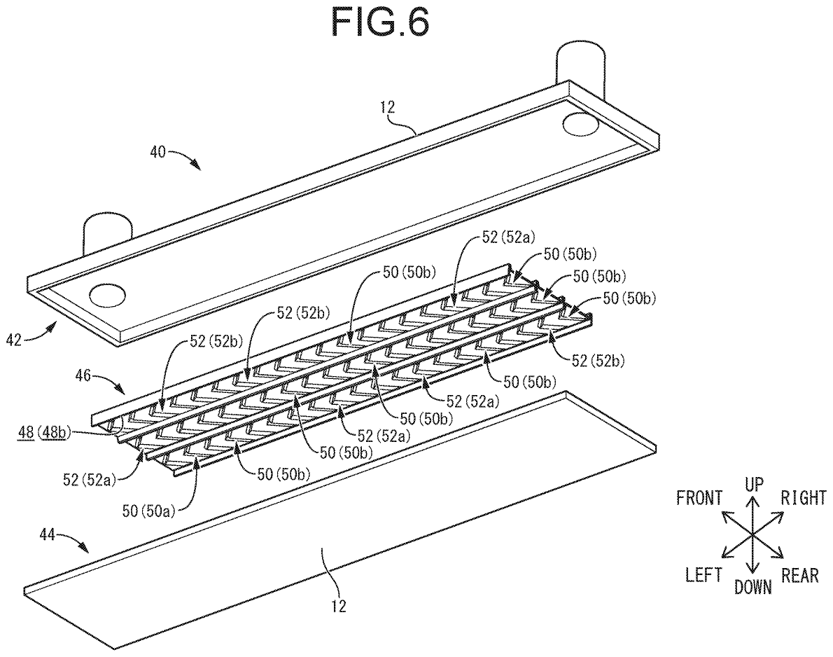

FIGS. 6-11 show a cooling heat exchanger 40 according to a second practical embodiment of the present disclosure. The cooling heat exchanger 40 has a structure in which an inner fin 46 is accommodated between superposing surfaces of an upper plate 42 whose upper surface is the cooling surface 12 and a lower plate 44 whose lower surface is the cooling surface 12. In the following description, components and parts that are substantially identical with those in the first practical embodiment will be assigned like symbols and not described in any detail.

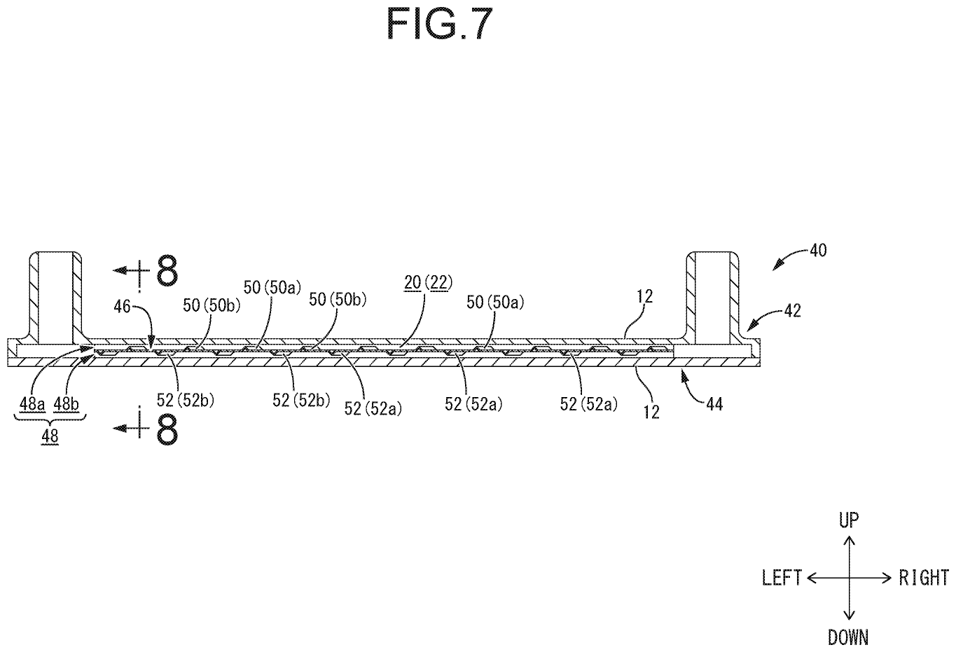

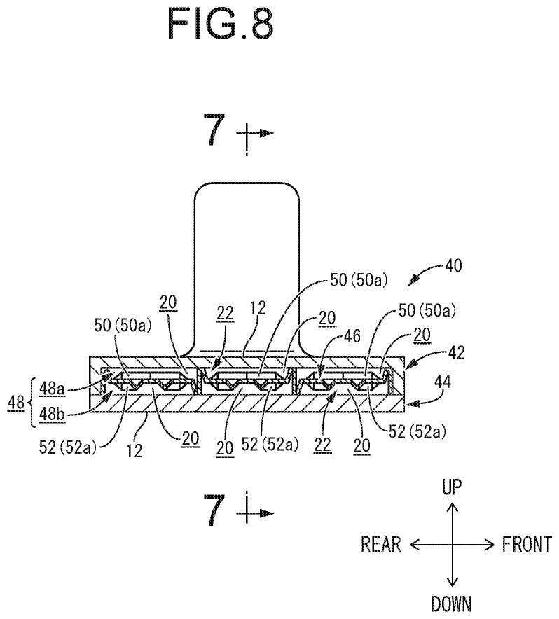

As shown in FIGS. 7 and 8, the cooling heat exchanger 40 has a cooling flow path 48 formed on both sides of the inner fin 46. That is, a front cooling flow path 48a is formed between the opposing surfaces of the inner fin 46 and the upper plate 42, and a back cooling flow path 48b on the back side is formed between the opposing surfaces of the inner fin 46 and the lower plate 44.

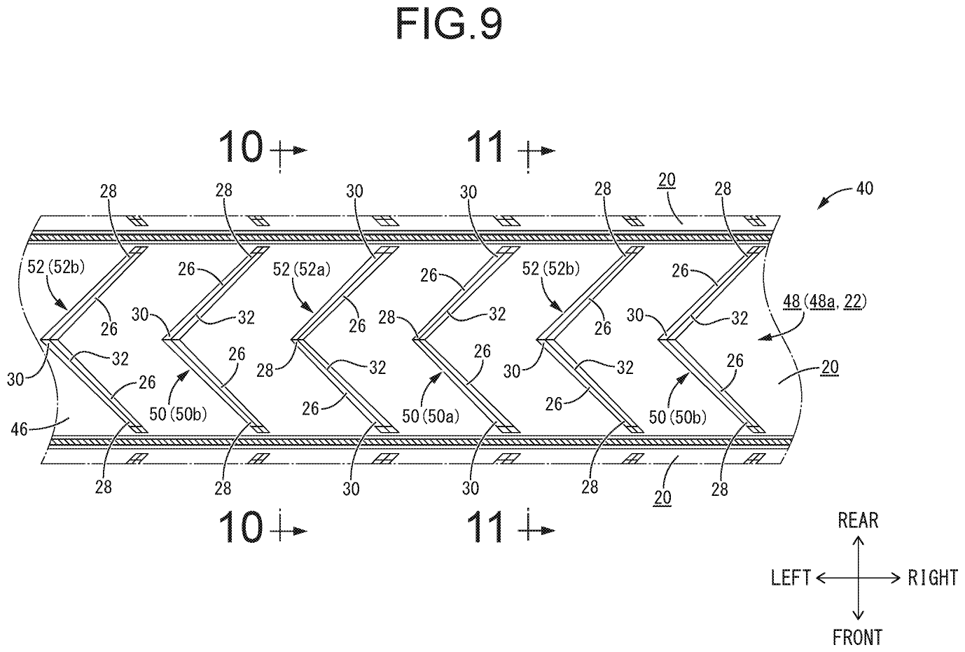

As shown in FIGS. 9 to 11, the inner fin 46 is formed with a front protrusion 50 protruding to the front cooling flow path 48a and a back protrusion 52 protruding to the back cooling flow path 48b, respectively. In short, the protrusions of the present practical embodiment include a plurality of front protrusions 50 and a plurality of back protrusion 52 protruding from each surface of the inner fin 46.

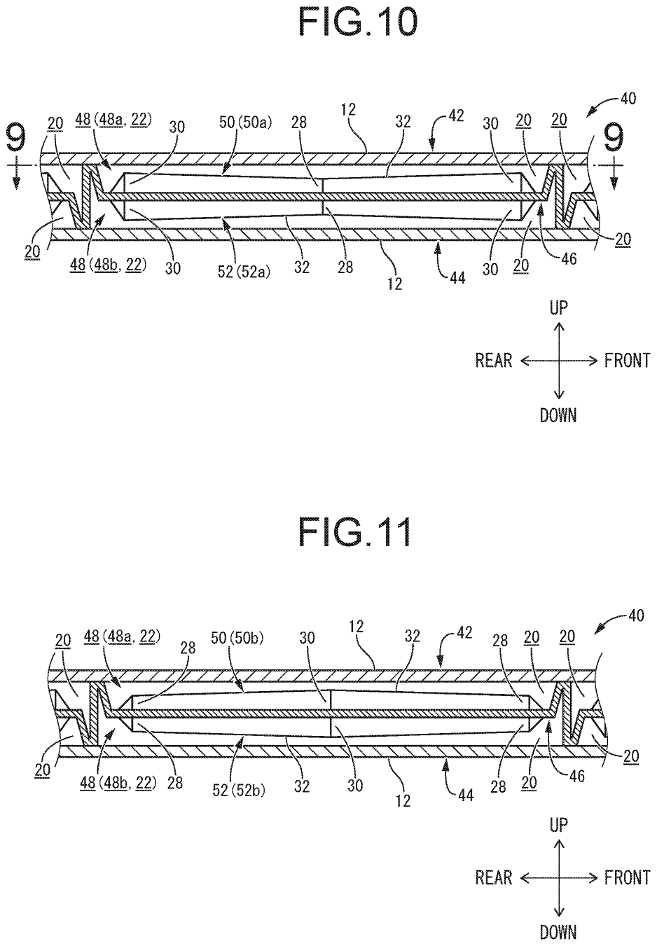

The front protrusion 50 and the back protrusion 52 are substantially V-shaped similarly to the protrusion 24 of the first practical embodiment. As shown in FIGS. 10 and 11, the front protrusion 50 includes a first front protrusion 50a as a first protrusion having the low protruding portion 28 at the central portion in the flow path width direction, and a second front protrusion 50b as a second protrusion having the low protruding portion 28 at both end portions in the flow path width direction. Similarly, the back protrusion 52 includes a first back protrusion 52a as a first protrusion having the low protruding portion 28 at the center portion in the flow path width direction, and a second back protrusion 52b as a second protrusion having the low protruding portion 28 at both end portions in the flow path width direction.

In addition, in the protrusions 50 and 52 of the present practical embodiment, the protruding heights of both end portions in the flow path width direction are rapidly reduced toward the outer side in the flow path width direction, and the height dimension is 0 without reaching the walls of the flow path portion 20. In other words, the change rate of the protrusion height at both end portions of the protrusions 50 and 52 is larger than that of the other portions. The protrusions 50 and 52 are provided only in the intermediate portion in the flow path width direction of the flow path portion 20, and do not reach both ends. Both end portions of the protrusions 50 and 52 have smaller protrusion height toward the outer side in the flow path width direction on either of the first protrusion and the second protrusion.

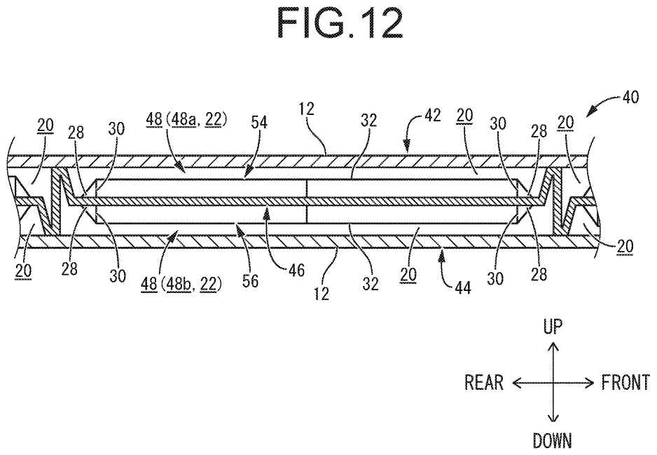

As the front protrusion 54 and the back protrusion 56 shown in FIG. 12, the intermediate portion in the flow path width direction is set to substantially constant protruding height dimension, and the protruding height dimension may be changed only at both end portions. In short, both end portions of the front protrusion 54 and the back protrusion 56 whose height is rapidly reduced toward the outside in the flow path width direction can also be regarded as a part of the inclined portions 26, 26.

In the cooling heat exchanger 40 of the present practical embodiment, a battery pack or the like (not shown) as a cooling target is superposed on each of the upper cooling surface 12 and the lower cooling surface 12. Then, the battery pack is cooled by heat exchange with the heat medium.

A front protrusion 50 protruding to the cooling flow path 48a and a back protrusion 52 protruding to the cooling flow path 48b are formed with respect to the inner fin 46 separating the cooling flow paths 48a, 48b. As a result, the stirring action by the protrusions 50, 52 is exerted on both of the heat medium flowing through the cooling flow path 48a and the heat medium flowing through the cooling flow path 48b, and the cooling performance by the stirring of the heat medium is improved.

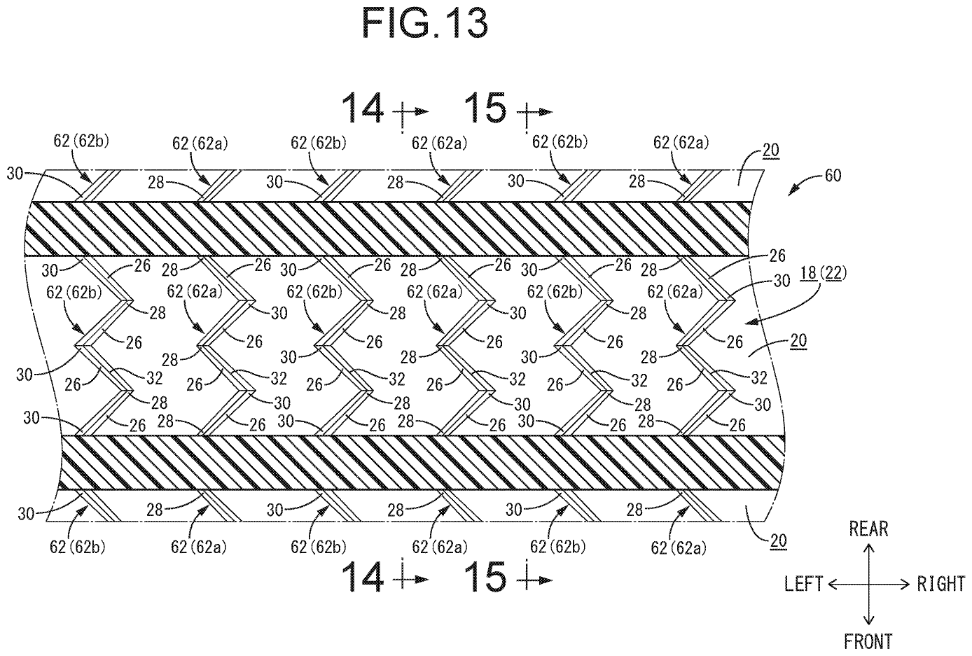

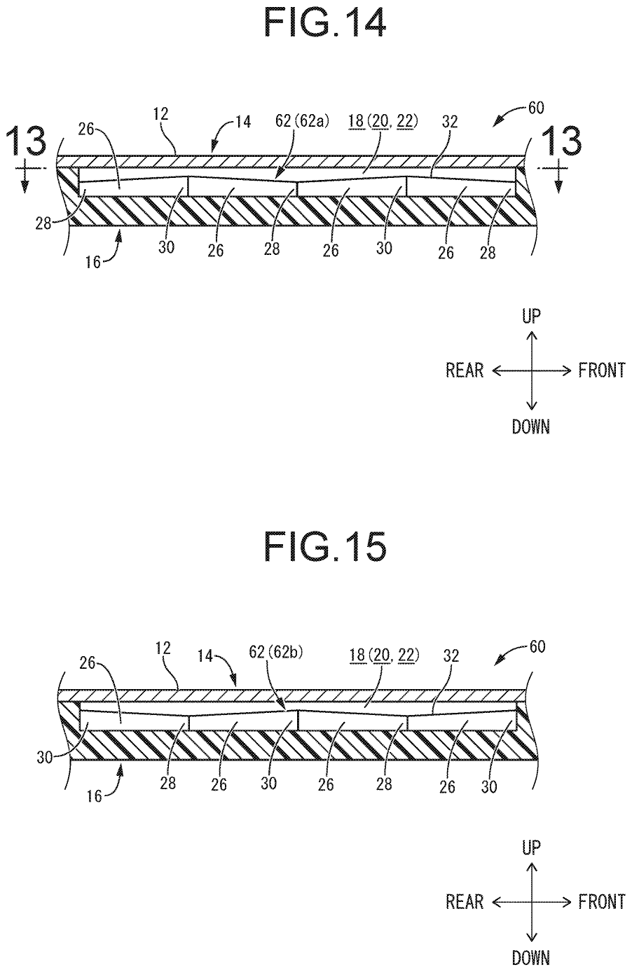

FIGS. 13-15 show a cooling heat exchanger 60 according to a third practical embodiment of the present disclosure. The cooling heat exchanger 60 includes a protrusion 62 protruding from the lower plate 16. The protrusion 62 of the present practical embodiment includes two inverted V-shapes, opposite direction to the protrusions 24 of the first practical embodiment, arranged in the flow path width direction are as viewed in the protruding direction shown in FIG. 13, and the protrusions 62 are formed in a substantially inverted W shape as a whole. Therefore, the protrusion 62 includes four inclined portions 26, 26, 26, 26, and one of the low protruding portions 28 and the high protruding portion 30 is set at each end portion of each inclined portion 26. In the four inclined portions 26, 26, 26, 26 constituting the protrusions 62, two extend in the same direction as each other, and the other two extend in the other direction. The protrusion 62 includes a first protrusion 62a in which the low protruding portions 28 are provided at the central portion and both end portions in the flow path width direction, and a second protrusion 62b in which the high protruding portions 30 are provided at the central portion and both end portions in the flow path width direction.

The cooling heat exchanger 60 of the present practical embodiment exhibits the same effects as those of the first practical embodiment.

In addition, for example, when the flow path width dimension of the flow path portion 20 is large, if one V-shaped or inverted V-shaped protrusion is provided, when the width dimension of the protrusion is to be set sufficiently large with respect to the flow path width dimension of the flow path portion 20, it is necessary to increase the length dimension of the protrusion in the length direction of the flow path, or to reduce the inclination angle of the inclined portion 26 with respect to the flow path width direction. However, any of these may adversely affects the improvement of the cooling performance by the protrusion. In the present practical embodiment, protrusions 62 in which two inverted V-shapes are arranged in the flow path width direction are adopted, and thus, even when the flow path width dimension of the flow path portion 20 is large, the length dimension in the flow path length direction of the protrusion 62 can be prevented from becoming excessively large, and the inclination angle of the inclined portion 26 with respect to the flow path width direction can be set with a large degree of freedom.

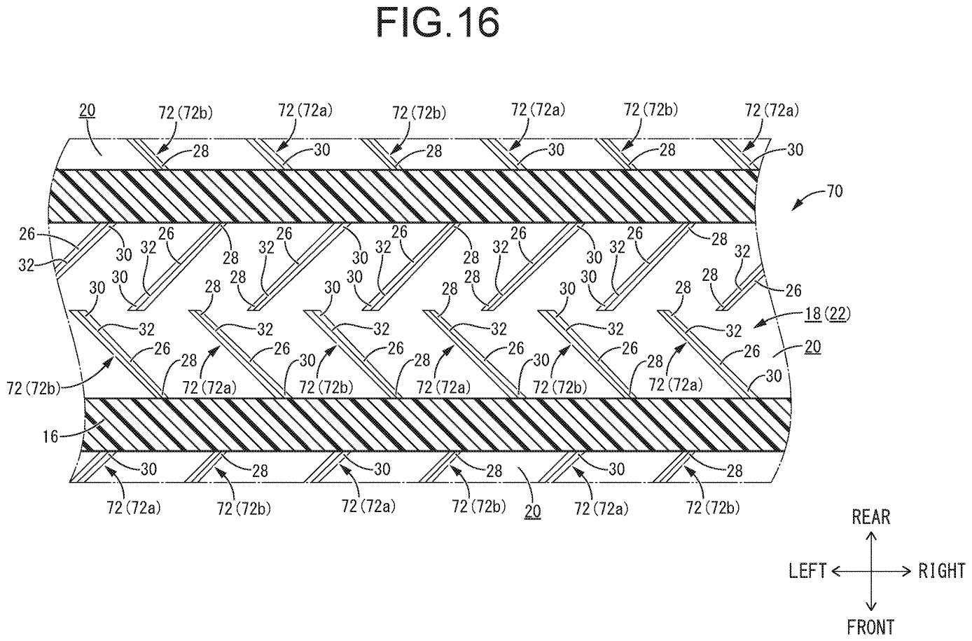

FIG. 16 shows a cooling heat exchanger 70 according to a fourth practical embodiment of the present disclosure. A protrusion 72 of the cooling heat exchanger 70 includes the pair of inclined portions 26, 26 disposed at positions shifted from each other in the flow path length direction, and includes a pair of inclined portions 26, 26 apart from each other. In the pair of inclined portions 26, 26, the protrusion 72 includes, a first protrusion 72a in which the low protruding portion 28 is provided at the central portion in the flow path width direction, and a second protrusion 72b in which the high protruding portion 30 is provided at the central portion in the flow path width direction.

In the present practical embodiment, the pair of inclined portions 26, 26 constituting the protrusion 72 are positioned such that the end portions on the center side of the flow path width that approach each other are positioned without a gap or superposed on each other as viewed in the flow path length direction. In addition, in the present practical embodiment, the pair of inclined portions 26, 26 each have the low protruding portion or the high protruding portion at the end portions on the center side of the flow path width that are adjacent to each other, and the they have substantially same protruding height. Further, in the present practical embodiment, the mutual separation distance in the flow path length direction between the end portions of the pair of inclined portions 26, 26 adjacent to each other on the center side of the flow path width is equal to or smaller than the dimension of each inclined portion 26 in the flow path length direction.

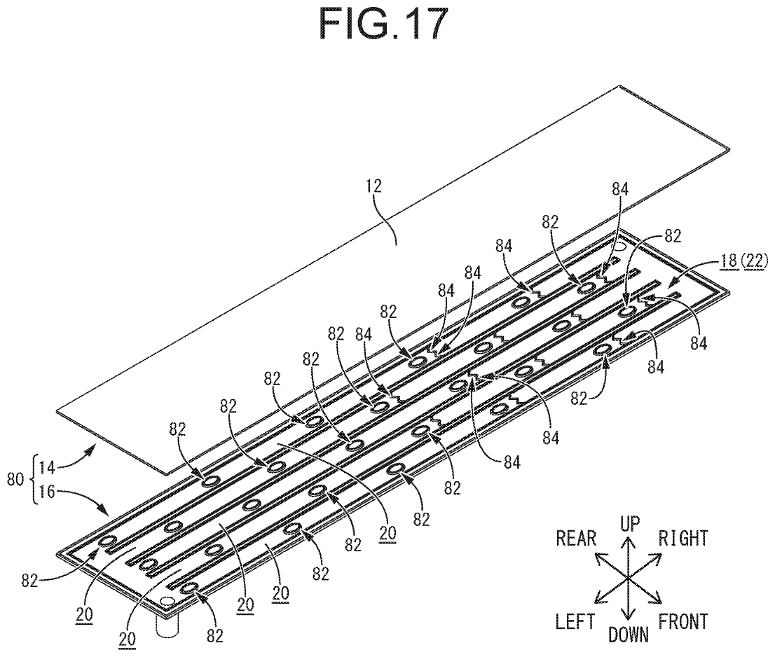

FIG. 17 shows a cooling heat exchanger 80 according to a fourth practical embodiment of the present disclosure. The cooling heat exchanger 80 includes a support portion 82 protruding from the lower plate 16 toward the upper plate 14, and the lower plate 16 and the upper plate 14 are fixed to each other by a support portion 82. A protrusion 84 is formed at a position adjacent to the downstream side of the support portion 82. The protrusion 84 is disposed at a position shifted lateral to the side, which is the outer side in the flow path width direction, with respect to the support portion 82, and is disposed, for example, on each side on the downstream side of the support portion 82. The protrusion 84 has a V-shape expanding both sides in the flow path width direction toward the downstream side, and includes the low protruding portion 28 and the high protruding portion 30 in the same manner as the protrusion 24 of the first practical embodiment.

According to the cooling heat exchanger 80 having the structure according to the present practical embodiment, for example, the fixing strength between the upper plate 14 and the lower plate 16 is improved by using the support portion 82 of the lower plate 16 as a fixing portion to the upper plate 14.

In addition, since the support portion 82 is provided on the flow path portion 20, the heat medium flowing through the flow path portion 20 flows separately to both sides in the flow path width direction with respect to the support portion 82. Therefore, by disposing the protrusion 84 on the side of the downstream side of the support portion 82 which is the flow path of the heat medium separated by the support portion 82, the flow of the heat medium can be guided toward the protrusion 84, and the stirring action or the like by the protrusion 84 can be efficiently obtained.

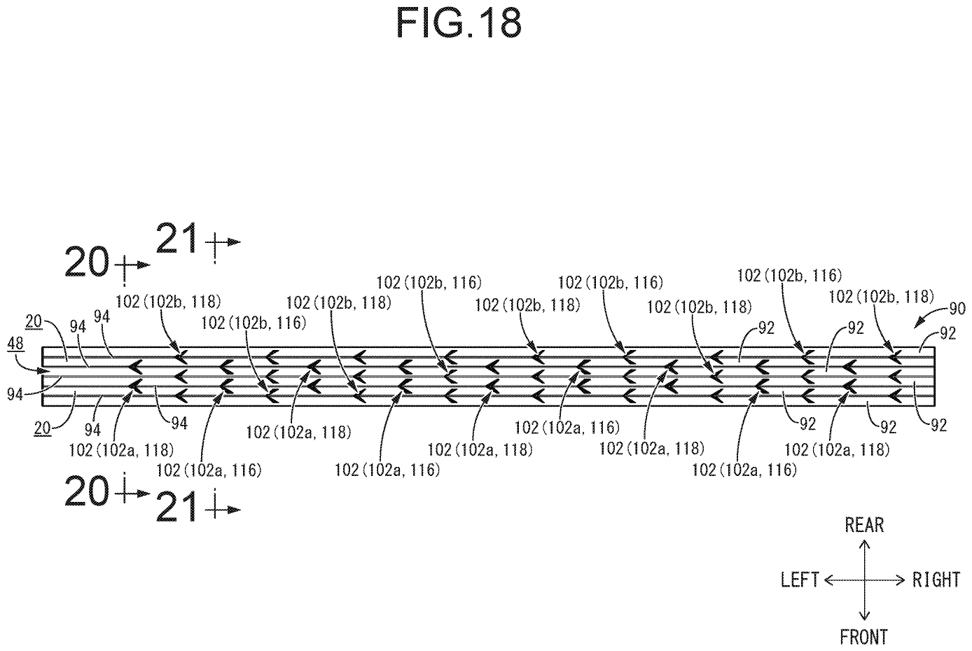

FIG. 18 shows an inner fin 90 constituting a cooling heat exchanger 80 according to a fourth practical embodiment of the present disclosure. Since the inner fin 90 of the present practical embodiment can be replaced with the inner fin 46 in the second practical embodiment, it may be described with reference to the symbols of the second practical embodiment with respect to components and parts that are substantially identical with those in the second practical embodiment. Besides, the left side in FIG. 18 is the upstream side of the cooling flow path, and the right side in FIG. 18 is the downstream side of the cooling flow path.

The inner fin 90 is formed of a metal, a synthetic resin, or the like, and has a thin plate shape. The inner fin 90 of the present practical embodiment is a press metal fitting. The inner fin 90 has a zigzag or wavy cross section. In the present practical embodiment, a plurality of flat-shaped swash plate portions 92 extending in the up-down direction and the front-rear direction are formed in a zigzag cross-section provided so as to be integrally continuous in the front-rear direction at the bent top portion 94. The inner fin 90 has a substantially constant cross-sectional shape and linearly extends in the left-right direction. The number of bends (the number of top portions 94) of the inner fin 90 having a zigzag shape or a wavy shape is not particularly limited. It is appropriately set in consideration of, for example, the width dimension of the cooling surface 12 and the flow path cross-sectional area of the flow path portion 20 defined by the inner fin 90.

Similarly to the inner fin 46 of the second practical embodiment, the inner fin 90 is disposed between the upper plate 14 and the lower plate 16. The inner fin 90 is positioned with respect to the upper plate 14 and the lower plate 16, for example, by brazing the top portion 94 to the upper plate 14 and the lower plate 16. The cooling flow path 18 between the upper plate 14 and the lower plate 16 is partitioned into a plurality of flow path portions 20 arranged in the flow path width direction by the inner fin 90. A plurality of the flow path portions 20 are formed on both upper and lower sides of the inner fin 90, and the cooling surface 12 of the upper plate 14 and the cooling surface 12 of the lower plate 16 are cooled by the heat medium flowing through the upper and lower flow path portions 20. The flow path portion 20 of the present practical embodiment has walls constituted by two swash plate portions 92, 92 continuous via one top portion 94 and the upper plate 14 or the lower plate 16, and has a substantially triangular cross section.

A protrusion 102 is formed in the inner fin 90. The protrusion 102 extends in a substantially V-shape on the surface of the inner fin 90, and is tapered (narrow) toward the upstream side of the cooling flow path. The protrusion 102 has a substantially V-shape when viewed in the vertical direction. The protrusions 102 includes a first protrusion 102a protruding from the upper surface side of the inner fin 90, and a second protrusion 102b protruding from the lower surface side of the inner fin 90.

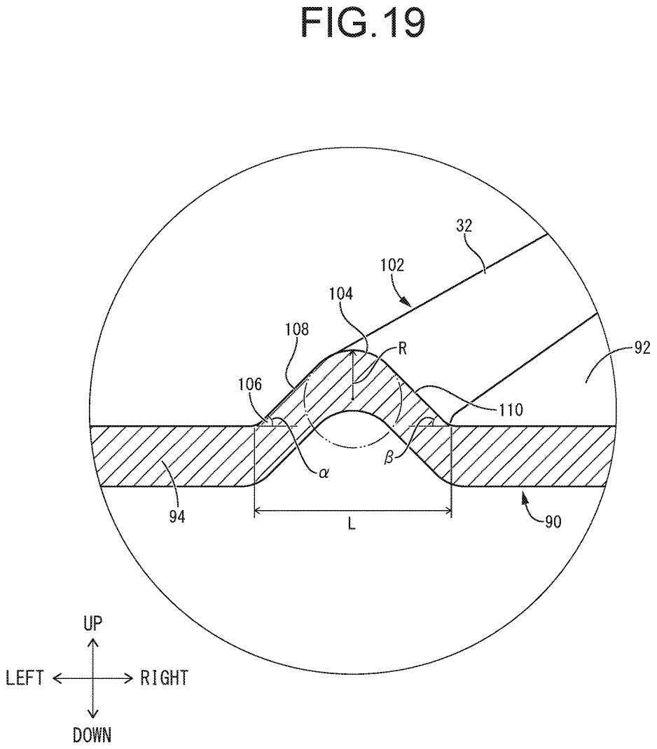

FIG. 19 shows an enlarged cross section of one protrusion 102 in the flow path length direction. In the cross section shown in FIG. 19, the protrusion 102 has a tapered cross-sectional shape that is narrower in the flow path length direction toward the protruding top. More specifically, in the cross section shown in FIG. 19, the protrusion 102 has a cross-sectional outer shape continuously provided with a protruding top 104 curved in an arc shape, an upstream inclined portion 108 extending from an upstream end portion of the protruding top 104 toward the upstream side toward the protruding base 106 (connection end portion with the swash plate portion 92 in the protrusion 102), and a downstream inclined portion 110 extending from an end portion on the downstream side of the protruding top 104 toward the protruding base 106 so as to be inclined toward the downstream side. Although the cross section of the protrusion 102 shown in FIG. 19 is a cross section in the flow path length direction passing through the center in the flow path width direction, any cross-sectional shape of protruding top 104 orthogonal to the ridge line 32 is similar to that of FIG. 19, and a numerical range similar to that in the description of FIG. 19 is suitably applied to any cross section orthogonal to the ridge line 32.

In the cross section in the flow path length direction shown in FIG. 19, the curvature radius R of the protruding top 104 including the ridge line 32 is preferably within the range of 0.05 to 1.5 times the length dimension L of the protruding base 106 in the flow path length direction, and is more preferably within the range of 0.2 to 1.45 times. Since the curvature radius R of the protruding top 104 is set to be 0.05 times or more with respect to the length dimension L of the protruding base 106, the protruding top 104 is formed into a smooth arc-shaped cross section without a substantial corner portion. Further, since the curvature radius R of the protruding top 104 is 1.5 times or less with respect to the length dimension L of the protruding base 106, the length dimension of the protrusion 102 in the flow path length direction can be prevented from becoming excessively long, and the inclination angles α and β of the upstream inclined portion 108 and the downstream inclined portion 110 smoothly continuous with the protruding top 104 can be set sufficiently large. In the present practical embodiment, the curvature radius R of the protruding top 104 is within a range of 0.05 to 0.5 times the length dimension L of the protruding base 106.

The upstream inclined portion 108 may have a curved shape, however in the present practical embodiment, the upstream inclined portion 108 has a linear shape. An upper end portion of the upstream inclined portion 108 extends in a tangential direction from the upstream end portion of the protruding top 104, and is smoothly continuous to the protruding top 104 without a corner portion. The lower end portion of the upstream inclined portion 108 nay be curved in an arc shape, and in this case, it is desirable that the upstream inclined portion 108 be smoothly continuous without a corner portion with respect to the swash plate portion 92 constituting the bottom surface of the cooling flow path 18.

The inclined angle α of the upstream inclined portion 108 with respect to the swash plate portion 92 constituting the bottom surface of the cooling flow path 18 is within the range of 20 to 70°, and more preferably within the range of 30 to 60°. When the upstream inclined portion 108 has a curved shape, the inclination angle α of the upstream inclined portion 108 with respect to the swash plate portion 92 can be identify as, for example, an average value of the inclination angle of the upstream inclined portion 108 with respect to the swash plate portion 92.

Since the inclination angle α of the upstream inclined portion 108 is 20° or more, the flow of the heat medium from the upstream side toward the protrusion 102 is effectively disturbed by the upstream inclined portion 108 which has a sufficiently large angle with respect to the flow direction of the heat medium, and the cooling performance by the stirring action is improved. Further, since the inclination angle α of the upstream inclined portion 108 is 70° or less, it is possible to prevent the flow of the heat medium from being excessively limited by the protrusion 102.

The downstream inclined portion 110 may have a curved shape, however in the present practical embodiment, the downstream inclined portion 110 has a linear shape. An upper end portion of the downstream inclined portion 110 extends in a tangential direction from the downstream end portion of the protruding top 104, and is smoothly continuous to the protruding top 104 without a corner portion. The lower end portion of the downstream inclined portion 110 nay be curved in an arc shape, and in this case, it is desirable that the downstream inclined portion 110 be smoothly continuous without a corner portion with respect to the swash plate portion 92 constituting the bottom surface of the cooling flow path 18.

The inclined angle β of the downstream inclined portion 110 with respect to the swash plate portion 92 constituting the bottom surface of the cooling flow path 18 is within the range of 20 to 70°, and more preferably within the range of 30 to 60°. When the downstream inclined portion 110 has a curved shape, the inclination angle β of the downstream inclined portion 110 with respect to the swash plate portion 92 can be identify as, for example, an average value of the inclination angle of the downstream inclined portion 110 with respect to the swash plate portion 92.

Since the inclination angle β of the downstream inclined portion 110 is 20° or more, the flow of the heat medium getting over the protrusion 102 is likely to be away from the downstream inclined portion 110, and thus an effect of easily generating a turbulent flow such as a vortex flow on the downstream side of the protrusion 102 is expected. Further, since the inclination angle β of the downstream inclined portion 110 is 70° or less, the flow of the heat medium along the downstream inclined portion 110 is also ensured, and efficient stirring of the heat medium due to merging with the flow away from the downstream inclined portion 110 is expected.

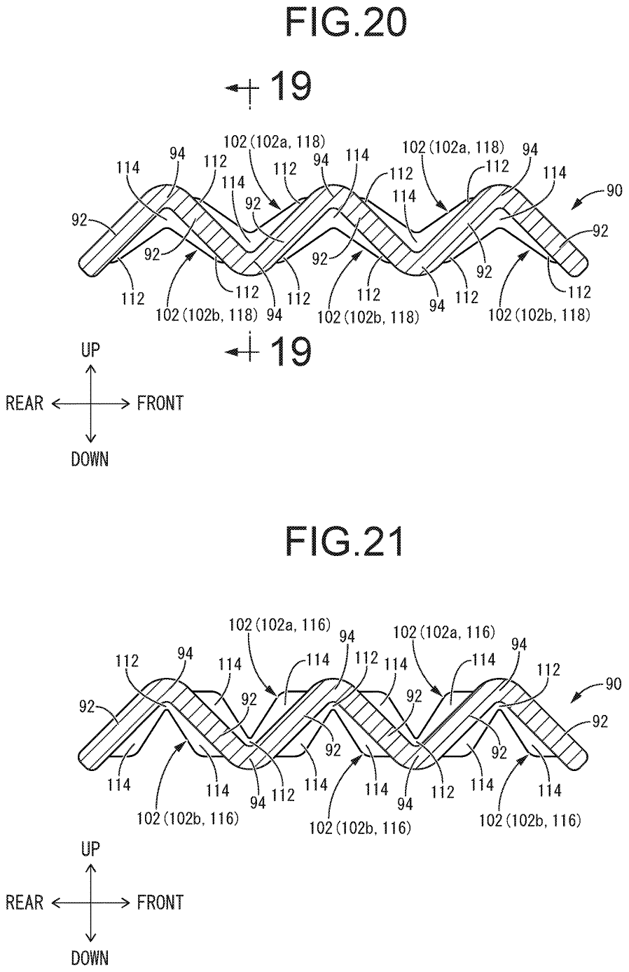

As shown in FIGS. 20 and 21, the protrusion 102 of the present practical embodiment changes in the front-rear direction in which the protruding height dimension is the flow path width direction. The plurality of protrusions 102 are constituted by; a central low protrusion 116 in which the front-rear center is a low protruding portion 112 having low protrusion height and the front-rear ends are high protruding portions 114 having high protruding height; and a central high protrusion 118 in which the front-rear center is the high protruding portion 114 having high protrusion height, and the front-rear ends are the low protruding portions 112 having low protrusion height. Each of the first protrusion 102a and the second protrusion 102b includes a plurality of central low protrusions 116 and a plurality of central high protrusions 118.

As shown in FIG. 18, the plurality of first protrusions 102a and the second protrusions 102b arranged in the flow path length direction are alternately arranged in the left-right direction in which the central low protrusion 116 and the central high protrusion 118 are the flow path length direction. Therefore, in the central portion in the flow path width direction of the flow path portion 20, the low protruding portion 112 of the central low protrusion 116 and the high protruding portion 114 of the central high protrusion 118 are alternately arranged in the flow path length direction. In addition, at both end portions in the flow path width direction of the flow path portion 20, the high protruding portions 114, 114 of the central low protrusion 116 and the low protruding portions 112, 112 of the central high protrusion 118 are alternately arranged in the flow path length direction.

According to the inner fin 90 of the present practical embodiment, the stirring action of the heat medium can be obtained more strongly in the high protruding portion 114 having a large protruding height dimension, and the flow resistance of the heat medium is suppressed by the low protruding portion 112 having a small protruding height dimension, so that the pressure loss is reduced.

In the present practical embodiment, the low protruding portion 112 and the high protruding portion 114 are disposed adjacent to each other in the flow path length direction, and the heat medium smoothly flowing through the low protruding portion 112 is then efficiently stirred by the high protruding portion 114 located on the downstream side of the low protruding portion 112, whereby the cooling performance can be efficiently improved. In addition, since the heat medium which is strongly disturbed by the high protruding portion 114 flows relatively smoothly through the low protruding portion 112 located on the downstream side of the high protruding portion 114, stagnation of the flow or the like is unlikely to occur.

In addition, although the heat medium easily flows through the low protruding portion 112 having smaller flow resistance than that of the high protruding portion 114, the central low protrusion 116 and the central high protrusion 118 are alternately arranged in the flow path length direction, so that the low protruding portions 112 are alternately positioned in the central portion and both end portions in the flow path width direction in the flow path length direction. Therefore, in the flow path portion 20, a flow of the heat medium meandering in the flow path width direction so as to connect the low protruding portions 112 is also generated, and an effect of eliminating the deviation of the temperature distribution of the heat medium in the flow path width direction is also expected.

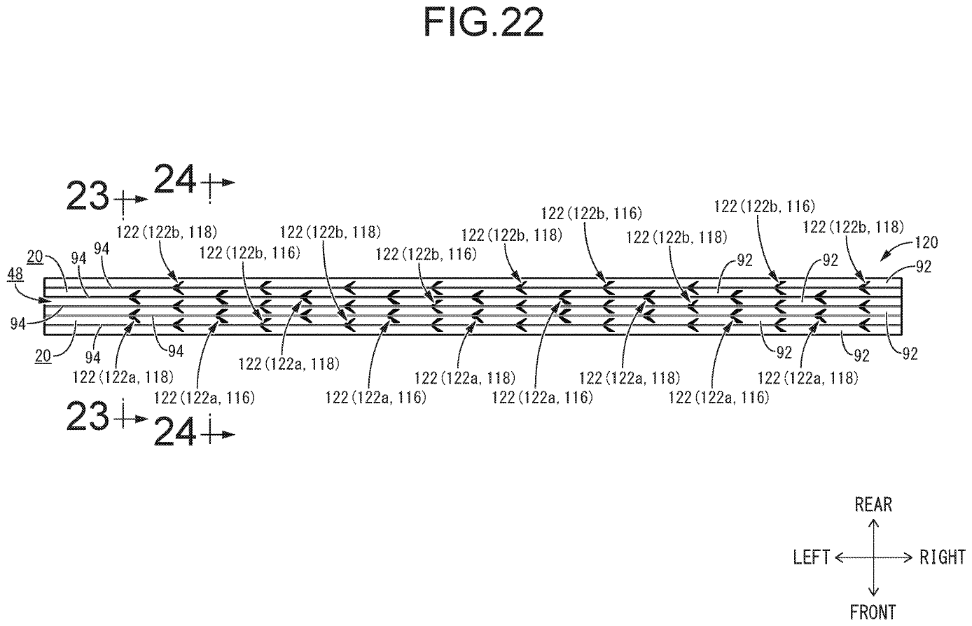

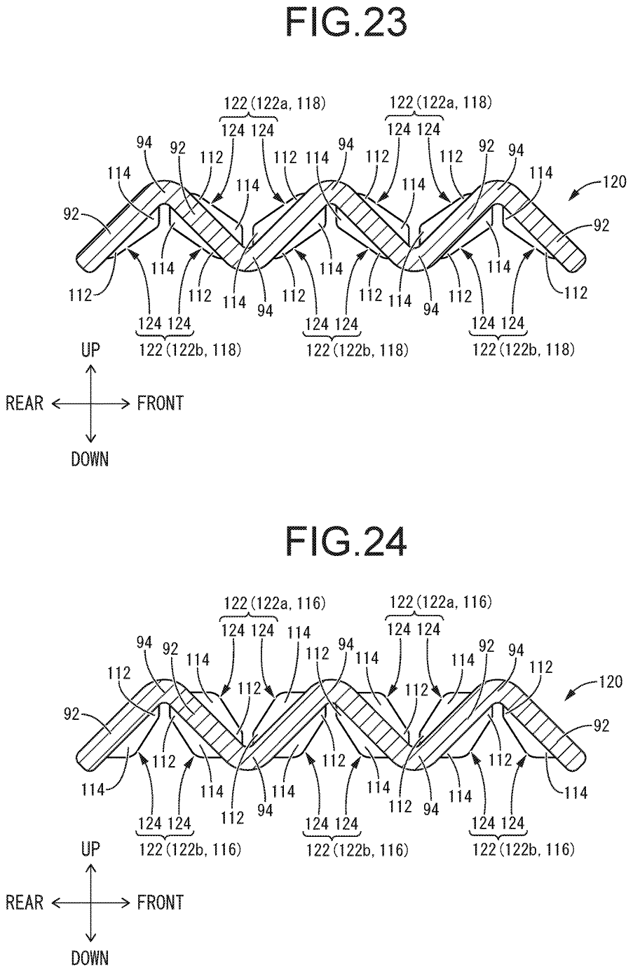

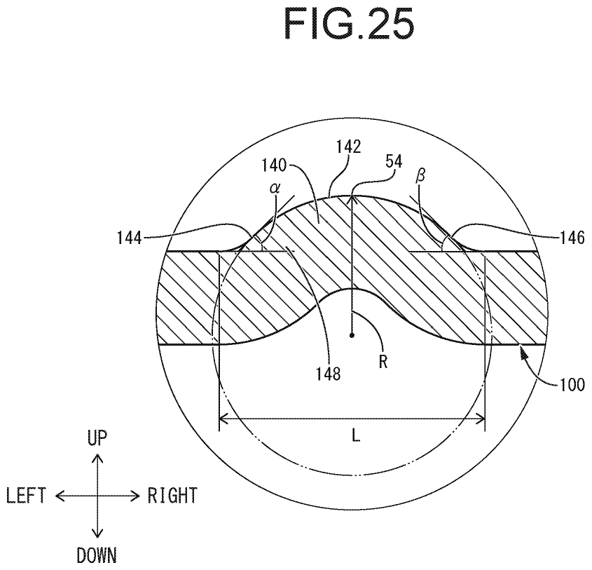

FIGS. 22 to 24 show an inner fin 120 constituting a cooling heat exchanger 80 according to a seventh practical embodiment of the present disclosure. The inner fin 120 has a zigzag cross-sectional shape similar to that of the inner fin 90 of the sixth practical embodiment.

The inner fin 120 is provided with protrusions 122. The protrusions 122 is constituted by a plurality of first protrusions 122a protruding from the upper surface and a plurality of second protrusions 122b protruding from the lower surface. Similarly to the protrusion 102 of the inner fin 90, the protrusion 122 has a substantially V-shape when viewed in the vertical direction but is not continuous at the end portion on the upstream side (the left side in FIG. 22). That is, the protrusion 122 of the present practical embodiment is constituted by two mutually separated convex portions 124, 124 extending from the center in the flow path width direction toward both sides so as to be inclined toward the downstream side (the right side in FIG. 22).

The protrusion 122 of the present practical embodiment includes a central low protrusion 116 and a central high protrusion 118 similarly to the protrusion 102 of the fifth practical embodiment. Further, in the present practical embodiment, the plurality of central low protrusions 116 and the plurality of central high protrusions 118 are alternately arranged in the flow path length direction. Since the protrusions 122 of the present practical embodiment are constituted by two convex portions 124, 124 mutually separated at the center portion in the flow path width direction, the low protruding portion 112 of the central low protrusion 116 and the high protruding portion 114 of the central high protrusion 118 located on the center side in the flow path width direction are provided in the two convex portions 124, 124, respectively.

By the inner fin 120 having the structure according to the present practical embodiment, the same effects as those of the inner fin 90 of the fifth practical embodiment can be obtained. In addition, since the protrusions 122 is provided only on the swash plate portion 92 and is not formed in the top portion 94, the protrusion 122 can be easily molded by pressing.

While the practical embodiments of the present disclosure have been described above in detail, the present disclosure is not limited by the specific statements of the practical embodiment. For example, although it is desirable that the height of the protrusion gradually changes from the low protruding portion toward the high protruding portion, the height may change in a stepped shape or stepwise.

When a plurality of protrusions are provided, the plurality of protrusions may have different shapes, sizes, intervals (arrangement density), and the like, for example.

The protrusion may have, for example, an inverted V shape extending toward both sides in the flow path width direction toward the upstream side. In addition, for example, the protrusions may have a W shape in which two V-shapes extending toward both sides in the flow path width direction toward the downstream side are arranged in the flow path width direction. Alternatively, the protrusion only needs to have at least partially one V-shaped or inverted V-shaped portion in the flow path width direction. For example, three or more V-shaped portions may be arranged.

Although FIG. 19 shows the protrusion 102 in which the inclination angle of the upstream inclined portion 108 is within the range of 20 to 70°, the protrusion 140 as shown in FIG. 25 can also be adopted, for example. That is, the protrusion 140 of FIG. 25 has a large radius of curvature of the protruding top 142, and both the upstream inclined portion 144 that is the upstream side and the downstream inclined portion 146 that is the downstream side are formed of curved surfaces, and is provided so as to connect the protruding top 142 and the swash plate portion 92 smoothly and continuously without a corner portion in the cross section of the flow path length direction. Therefore, the entire cross-sectional outer shape of the protrusion 140 in the flow path length direction is a continuous curved shape. In addition, in the protrusion 140 of FIG. 25, the curvature radius R of the protruding top 142 formed in an arc shape in the cross section in the flow path length direction is preferably set to a size of 0.7 times or more with respect to the length dimension L of the protruding base 148, and is more preferably set to a size of 1 time or more. Further, in the cross section in the flow path length direction shown in FIG. 25, the inclination angle α of the upstream inclined portion 144 of the present practical embodiment with respect to the bottom surface of the flow path portion 20 is 25° or less, and the inclination angle β of the downstream inclined portion 146 of the present practical embodiment is 25° or less. In short, the protrusion 140 of the present practical embodiment has a flat shape in which the ratio of the protrusion height dimension to the length dimension L of the protruding base 148 is small in the cross section in the flow path length direction as compared with the protrusion 102 shown in FIG. 19, so that the change rate of the flow path cross-sectional area by the protrusion 140 is small. According to such a protrusion 140, since the pressure loss caused by the heat medium flowing over the protrusion 140 is suppressed, the heat medium can be circulated by using an inexpensive pump having relatively low performance.

Although the protrusion does not necessarily need to be provided continuously over the entire flow path width direction of the flow path portion, the width dimension of the protrusion in the flow path width direction is preferably 50% or more, more preferably 70% or more, with respect to the flow path width dimension of the flow path portion. As a result, a flow bypassing the protrusion is limited, and the flow over the protrusion is likely to occur, so that the effect of disturbing the flow of the heat medium by the protrusion is efficiently exhibited. When a zigzag inner fin is employed, for example, in case the flow path width dimension of the flow path portion changes in the flow path depth direction, the width dimension of the protrusion is preferably 50% or more, more preferably 70% or more, with respect to the maximum width dimension of the flow path portion (the width dimension between the protrusion tops in the zigzag inner fin). When the flow path width dimension of the flow path portion changes in the flow path length direction, it is desirable that the width dimension of the protrusion be set within the above range with respect to the flow path width dimension at the position where the protrusion is provided.

Although the pair of inclined portions constituting the protrusion do not necessarily have the same shape or size, the lengths may be different from each other, or the maximum protruding height and/or the minimum protruding height may be different from each other. In addition, the inclination angles of the pair of inclined portions in the flow path width direction with respect to the flow path length direction line may be different from each other.

For example, the low protruding portion may be provided in an intermediate portion of the inclined portion, and the high protruding portion may be provided at each end portion of the inclined portion. In short, only one of the low protruding portions and the high protruding portion may be provided in one inclined portion, whereas, at least either of the low protruding portions and the high protruding portions may be provided plurally in one inclined portion. In addition, at least one of the low protruding portions and the high protruding portion may be provided in one protrusion, and for example, a low protruding portion may be provided in one inclined portion, and a high protruding portion may be provided in the other inclined portion.

Further, the inclination angle (the inclination angle in the flow path width direction with respect to the flow path length direction line) in the pair of inclined portions is not limited. In addition, when adopting an embodiment in which the height dimension continuously changes between the low protruding portion and the high protruding portion in the inclined portion, the change rate of the height and the change amount of the height are not limited. In addition, when an embodiment in which the height dimension changes continuously between the low protruding portion and the high protruding portion is adopted, the change region of the height dimension does not need to be entire of the inclined portion, and it is not limited to how much the change region is set with respect to entire of the inclined portion. In addition, the protrusion does not need to be provided entire of the flow path width direction, and it is not limited to how much the protrusion is provided with respect to entire of the flow path in the flow path width direction. Further, the height dimension of the protrusion can be appropriately set, and the ratio of the height direction dimension of the flow path to the height direction dimension of the flow path is not limited to the high protrusion portion and the low protrusion portion of the protrusion. The cross section orthogonal to the extending direction of the inclined portion is not limited to a triangular cross-sectional shape. In addition, the cross section orthogonal to the extending direction of the inclined portion is not limited to the substantially similar shape in the extending direction of the inclined portion, and may be a different shape in the extending direction of the inclined portion. Further, the width dimension in the flow path length direction of the inclined portion does not need to change according to the height, and may be constant.

For example, when two types of protrusions, such as the first protrusion 24a and the second protrusion 24b in the first practical embodiment, are provided, the two types of protrusions may be placed every two or three ones in the flow path length direction, and the same type of protrusions may be disposed adjacent to each other in the flow path length direction.

The cooling flow path may not necessarily include the parallel flow path portion including a plurality of flow path portions arranged in parallel, or may be constituted by one flow path portion. Further, in one flow path portion, a plurality of protrusions may be arranged in the flow path width direction. The plurality of flow path portions constituting the parallel flow path portion may have different depths, widths, lengths, and the like.

The cooling flow path is not limited to be linearly extending, and may extend in a U-shape, a meandering shape, or an L-shape, for example.

The other plate (lower plate 16) on which the protrusions are provided may be made of metal.

The cooling heat exchanger is not necessarily limited to the structure in which two plates (the upper plate 14 and the lower plate 16 of the embodiment) are superposed, and may be, for example, a tube shape or the like, and the entire wall of the cooling flow path may be constituted by one member.

What is claimed is:

1. A cooling heat exchanger in which a cooling flow path through which a cooling heat medium flows is formed between two plates having a cooling surface, at least one of the plates superposed on a cooling target, comprising:
at least one protrusion provided on a wall of the cooling flow path, extending in a direction intersecting a flow path length direction of the cooling flow path, wherein
the protrusion is provided with a pair of inclined portions respectively, extending both sides of a flow path width direction toward the flow path length direction of the cooling flow path, and
the pair of inclined portions comprises a low protruding portion having low height and a high protruding portion having high height.

2. The cooling heat exchanger according to claim 1, wherein the protrusion is V-shaped as viewed in a direction of protruding.

3. The cooling heat exchanger according to claim 1, wherein height of the protrusion gradually increases from the low protruding portion toward the high protruding portion.

4. The cooling heat exchanger according to claim 1, wherein the at least one protrusion comprises a plurality of protrusions, the plurality of protrusions are arranged in the flow path length direction of the cooling flow path, and
the plurality of protrusions arranged in the flow path length direction include a plurality of types in which positions of the low protruding portions in the flow path width direction are different from each other and positions of the high protruding portions in the flow path width direction are different from each other.

5. The cooling heat exchanger according to claim 1, wherein one of the low protruding portions and the high protruding portion is located at a central portion of the protrusion in the flow path width direction, and the other of the low protruding portion and the high protruding portion is located at both end portions of the protrusion in the flow path width direction.

6. The cooling heat exchanger according to claim 5, wherein the at least one protrusion comprises a plurality of protrusions, the plurality of protrusions are provided in the flow path length direction of the cooling flow path, and
the plurality of protrusions include a first protrusion in which the low protruding portion is set at the central portion of the protrusion in the flow path width direction and the high protruding portion is set at both end portions of the protrusion in the flow path width direction, and a second protrusion in which the high protruding portion is set at the central portion of the flow path width direction and the low protruding portion is set at both end portions of the flow path width direction, and the first and second protrusions are alternately arranged in the flow path length direction.

7. The cooling heat exchanger according to claim 1, wherein the cooling surface is set on one of the two plates, and the protrusion is formed on other of the two plates.

8. The cooling heat exchanger according to claim 7, wherein a support portion protruding from the other of the two plates is fixed to one of the two plates, and the protrusion is located on a lateral side adjacent to a downstream side of the support portion.

9. The cooling heat exchanger according to claim 1, wherein each of the two plates includes the cooling surface,
an inner fin is disposed between the two plates, the cooling flow path is formed on both sides of the inner fin, and
the inner fin is provided with a front protrusion, which is the protrusion protruding toward the one of the cooling flow paths, and a back protrusion, which is the protrusion protruding toward the other of the cooling flow paths.

10. The cooling heat exchanger according to claim 1, wherein the cooling flow path includes a parallel flow path portion including a plurality of flow path portions extending in parallel, and
the plurality of protrusions are arranged along the flow path length direction with respect to the flow path portions constituting the parallel flow path portion.

11. The cooling heat exchanger according to claim 1, wherein a flow path length of the cooling flow path is 200 mm or more.

12. The cooling heat exchanger according to claim 1, wherein the protrusion extends across entire of the flow path width of the cooling flow path and is continuous with side walls of the cooling flow path at its both end portions.

13. The cooling heat exchanger according to claim 1, wherein the protrusion has a cross-sectional shape tapered toward its protruding top in a cross section of the flow path length direction of the cooling flow path, the protrusion has an arc-shaped protruding top, an upstream inclined portion, and a downstream inclined portion, and these portions provided smoothly and continuously without a corner portion, the upstream inclined portion extending from the protruding top toward a protruding base that is a side of a bottom surface of the cooling flow path so as to be inclined toward an upstream side of the cooling flow path, and the downstream inclined portion extending from the protruding top toward the protruding base so as to be inclined toward a downstream side.

14. The cooling heat exchanger according to claim 13, wherein, in the cross section of the flow path length direction of the cooling flow path, a radius of curvature of the protruding top is within a range of 0.05-1.5 times a length dimension of the protrusion base, and
in the cross section of the flow path length direction of the cooling flow path, an inclination angle of the upstream inclined portion with respect to the bottom surface of the cooling flow path is within a range of 20°-70°.

15. The cooling heat exchanger according to claim 13, wherein, in the cross section of the flow path length direction of the cooling flow path, an inclination angle of the upstream inclined portion with respect to the bottom surface of the cooling flow path is 25° or less.

16. A cooling heat exchanger in which a cooling flow path through which a cooling heat medium flows is formed and which cools a cooling target superposed on a cooling surface, comprising:
a protrusion provided on a wall of the cooling flow path, extending in a direction intersecting a flow path length direction of the cooling flow path, wherein
the protrusion is provided with a pair of inclined portions respectively, extending both sides of a flow path width direction toward the flow path length direction of the cooling flow path, and
the pair of inclined portions comprises a low protruding portion having low height and a high protruding portion having high height.
